(19) United States
(12) Patent Application Publication
(10) Pub. No.: US 2007/0288848 A1
(43) Pub. Date: Dec. 13, 2007

(54) Apparatus and method for controlling video signals

(76) Inventors: Masaharu Sakamoto, Sousa-shi (JP); Tadayuki Nakazawa, Tokyo (JP)

Correspondence Address: MURAMATSU & ASSOCIATES;Suite 310, 114 Pacifica, Irvine, CA, 92618, US

(21) Appl. No.: 11/449,404

(22) Filed: Jun. 8, 2006

(51) Int. Cl. G06F 3/00

(52) U.S. Cl. 715/732

(57) ABSTRACT

An apparatus for controlling video signals to be presented on a display device associated with a first audible signals, the apparatus comprises an intensity controller for receiving the video signals having a plurality of video signal components, the intensity controller being arranged so that an intensity control voltage independently controls amplitude of at least one of the plurality of video component signals to vary intensity of the of the video singles, a filter for receiving the first audible signals and separating the first audible signals into a plurality of filtered audible signals, each filtered audible signal being characterized by different frequency ranges, and a regulating circuit for regulating the filtered audible signals to form the intensity control voltage.

### BACKGROUND OF THE INVENTION

1. Field of the Invention

The present invention relates to an apparatus and a method for controlling video signals, more particularly, to an apparatus and a method for varying the intensity of video signals including a still picture by audible signals, the video signals being displayed on a display device associated with the audible signals to create and obtain synergistic effects of the visual sensation and the auditory sensation by synchronizing video signals and audio signals.

2. Description of Prior Art

In the theatrical world, it has been well known that in order to enhance the atmosphere of a play performed on a stage, color lights have provided and selected to enhance visual presentation of the scene performed on the stage in response to the scene of the story. In movie films, in order to create the most effective impression of the scene, music or a tune, which matches to the story of the movie has been played along with the scene of the movie.

There are many situations where a photographer desires to sophisticatedly present his or her photographs displayed on a screen at the presentation. In these situations, sometimes background music, which matches with the photographs has been selected in advance and presented in accordance with the presentation of the photographs.

However, in either case, visual expression performed on the stage and auditory expression have been independently presented in these situations.

More highly sophisticated video controllers or methods capable of enhancing the expression of the video signals associated with audio or sound signals have been required in these situations, particularly in a situation where a photographer present his or her works at art shows or conventions. Particularly when the video signals or images including still pictures or photographs can be memorized in an electronic form, reproduction capability of the video images associated with audible signals and portability associated with a video presentation system including a video controller to control the video signals and the audible signals haven been also demanded.

Many different apparatuses for displaying sound signals, particularly when the sound is music or audible signals, have been proposed as a presentation system. U.S. Pat. No. 5,784,096 issued to Paist discloses an apparatus for displaying two-channel audio input signals in a three-color pattern. In Paist patent, one of two-channel audio signals is inputted to a phase shifter and mixed together with the other audio channel signals. Then the mixed audio signals are separated into three frequency bands by filter devices and fed to a color cathode ray tube (CRT). The Paist patent permits the simultaneous presentation of a plurality of colors, which corresponds to an audio input.

Another related art is U.S. Pat. No. 4,128,846 issued to Robinson, Jr., which discloses an apparatus and method for modulating color contributions in visual displays with audio modulating signals. According to Robinson patent, the audio modulating signal is operated on a gating circuit controlled by enabling signals from a voltage controlled oscillator. A level detector samples the modulating singles and feeds control signals to the voltage controlled oscillator in response to values of amplitude detected in the modulating signals so that the audio signals can be displayed with several colors in response to the frequency and magnitude of the audio signals.

As noted above, there are rudimentary examples or prior arts, which seem to be relevant to the present invention. However, in any event, these prior arts have been trying to display audible signals themselves on a display screen with several colors.

### SUMMARY OF THE INVENTION

An object of the present invention is to provide an apparatus and method for creating and enhancing synergistic effects of the visual sensation and the auditory sensation by varying the intensity of video images in response to the frequency and the signal level of audio or sound signals associated with the video images.

In accordance with one of the aspect of the present invention, an apparatus for controlling video signals to be presented on a display device associated with a first audible signal, the apparatus comprises an intensity controller for receiving the video signals having a plurality of video signal components, the intensity controller being arranged so that an intensity control voltage independently controls an amplitude of at least one of the plurality of video component signals to vary intensity of the of the video singles, a filter for receiving the first audible signal and separating the first audible signal into a plurality of filtered audible signal, each filtered audible signal being characterized by different frequency ranges, and a regulating circuit for regulating the filtered audible signals to form the intensity control voltage.

According to the present invention, it becomes possible to vary the intensity of the video images by appropriately selecting one of the frequency band of the audible signals and adjusting the intensity of the video images by manually or automatically controlling the level of the reference signal source, which enables to vary the intensity of the video image apart from the brightness which the video image itself posses based on the contents or atmosphere where the video images are presented.

In another aspect of the present invention, the apparatus further comprises a second audible signal source, and a second volume control device for varying the amplitude of second signals of the second signal source, wherein the second signals are used for varying the level of the regulated waveform signals.

In another aspect of the present invention, the apparatus described above, wherein a program running on a computer can adjust the second audible signals connected to the apparatus, and the program includes a subprogram for registering an envelope in advance so that the video signals can be shaped according to the envelope.

According to the present invention it becomes possible to vary the intensity of the video signals not only by the audible signals associated with the video signals, such as narration and background music, but also the envelope which an operator can specify in advance.

In a further aspect of the present invention, the apparatus further comprises a third volume control device for receiving third audible signals to be mixed with the intensity control voltage.

According to the present invention, it becomes possible to use for example, metronome rhythm to vary the intensity of the video signals by inputting the metronome sound as the third audible signals.

### BRIEF DESCRIPTION OF THE DRAWINGS

FIG. 1 is a schematic diagram illustrating a visual image presentation system including a video controller of the present invention.

FIG. 2 is a block diagram illustrating the circuitry used in the video controller shown in FIG. 1.

FIG. 3 is a schematic block diagram illustrating a circuitry for varying the intensity of each component of analog R.G.B. signals.

FIG. 4 is a schematic diagram for filtering and regulating audible signals to convert audible signals into direct current (DC) voltage.

FIG. 5 is a schematic diagram showing one of examples of the present invention illustrating the relationship between three types of filters and corresponding signal components of analog RGB signals.

FIG. 6 is a schematic diagram of a part of functional block for producing control signals in the controller according to the present invention.

FIG. 7 illustrates a functional block diagram of a mixing and adjusting circuit shown in FIG. 6.

### DETAIL DESCRIPTION OF THE INVENTION

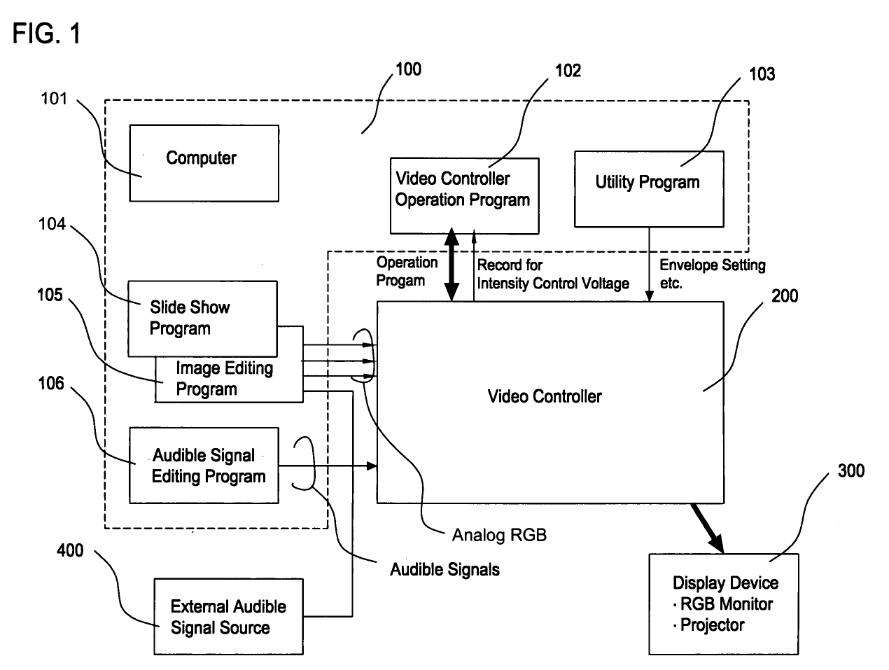

The embodiments of the present invention will be described in detail below with reference to the accompanying drawings. FIG. 1 is a schematic diagram illustrating a visual image presentation system including an audiovisual computer system 100 for controlling a video controller 200, a display device 300 for displaying video images, and an external audible signal source 400.

More specifically, the audiovisual computer system 100 includes a computer 101 on which a video controller operation program 102 for operating a video controller 200, an utility program 103 for setting appropriate envelopes of control signals used in the video controller 200 (which will be described in detail later), a slide show program 104 for displaying the video images according to a predetermined sequence, an image editing program 105 for editing the video images and related audible signals, and an audible signal editing programs 106 for editing the sound data or audio signals in advance.

The video controller 200 is used for controlling the intensity of analog RGB signals by applying audible signals inputted from the audiovisual computer system 100. The video controller 200 is arranged so that the video controller 200 is operated by the video controller operation program 102 running on the computer 101 in the audiovisual computer system 100 and/or by a manual operation of an operator of the video controller 200.

The video controller 200 is also used for creating an audio-visual presentation sequence into which video-images and sound signals are placed in the order of presentation according to the predetermined sequence controlled by the slide show program 104. The video controller 200 also is used for manually manipulating the video images to be displayed on the display device 300 by using an audible signals to vary the intensity of the analog RGB signals by using control knobs provided on the video controller 200 and or by using the video controller operating program 102.

In this embodiment, the external audible signal source 400 is arranged to communicate with the image-editing program 105 through an audio input terminal provided on the computer 101. The external audible source 400 is useful when special waveform, such as the waveform of a metronome is required. The metronome sound signals can be picked up by a microphone and inputted onto the audiovisual computer system 100 after appropriately amplified to a necessary input signal level.

The external audible signals from the external audible signal source 400 are inputted into an analog to digital converter (not shown) in the computer 101 and stored in the memory (not shown) in the computer 101. The audible signals converted into digital form stored in the memory are edited by the audible signal editing program 106 and inputted to the video controller 200 as audible signals when it is necessary to be input.

In this embodiment, the audible signal inputted to the video controller 200 are analog signals since the audible signals converted into digital form are reconverted back into analog from when inputted to the video controller 200. However, it is not limited to the analog form. A digital form of the audible signals may also be feasible if the video controller is designed based on the digital systems or the function of the video controller 200 is realized by software.

With regard to analog RGB signals fed to the video controller 200, in this embodiment, video image signals to be displayed on the display device 300 are fed from the memory (not shown) in the computer 101 in a form of analog RGB signals. The same as the audible signals, the video image signals are converted into digital form when stored into the memory in the computer 101. When inputting the video image signals into the video controller 200, the digitized video image data are converted back to analog RGB signals in the audiovisual computer system 100. In this embodiment, the analog RGB signals format are employed. However, it should be noted that the signal format is not limited to the analog RGB signals. Digital RGB signals may be also used as the video image signal format if the video controller 200 is designed based on the digital RGB signal format.

The slide show program 104 is provided for displaying the video images, which have been arranged to play back the series of video images stored in a memory device of the computer 101 on the display device 300 through the video controller 200. The slide show program 104 transfers video image signals together with the associated audible signals to the video controller 200. At the same time, series of parameters and commands for varying the intensity of the video image signals are transferred through the data bus described above to the video controller 200.

The image editing program 105 is a computer program specially provided for inserting and setting the necessary video image data into the target time slot in a video stream associated with the audible signals to be used for varying the intensity of the video images.

The utility program 103 is provided particularly for modulating the amplitude of a control signal for varying the intensity of the video image signals with specific envelopes stored in the computer 101 in advance. The utility program is also used for registering the envelopes characterized by amplitudes and duration time of the envelope.

The video controller operation program 102 running on the computer 101 controls the video controller 200 through a data bus provided between the video controller 200 and the audiovisual computer system 100 by issuing commands and associated parameter or data for operating the video controller 200. The operation of the video controller will be described later.

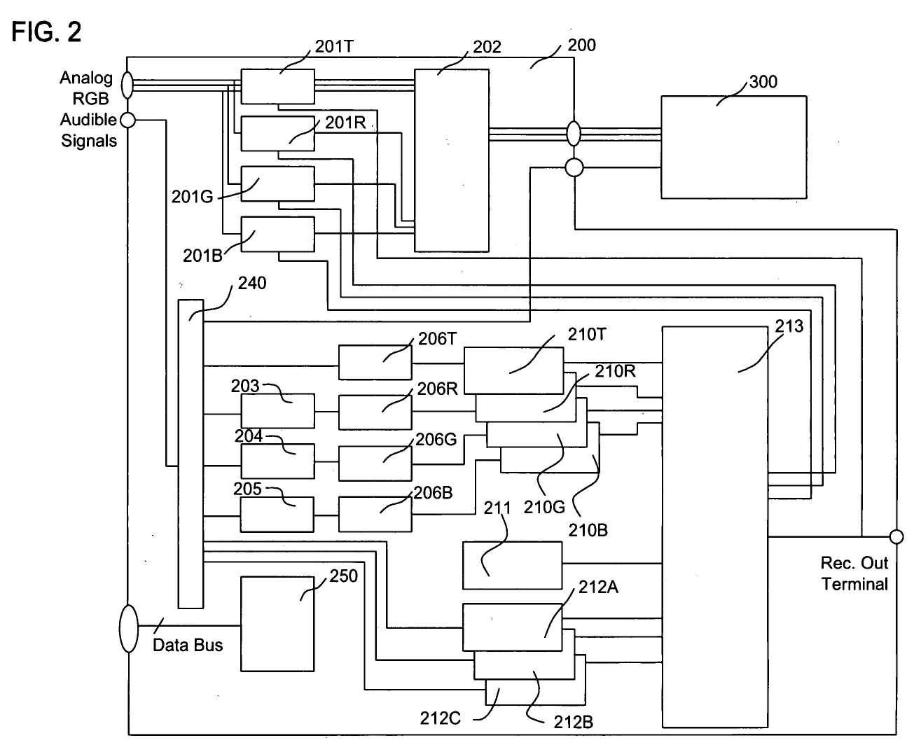

FIG. 2 is a schematic block diagram illustrating an overall circuitry in the video controller 200. The analog RGB signals and the audible signals are fed into the video controller 200 as input signals. In this embodiment of the present invention, the analog RGB signals and audible signals are supplied from the audiovisual computer system 100, however it is not limited to the audiovisual computer system 100. They may be independently outputted from external signal source or the video controller 200 may contain the video signal source and/or audible signal source therein.

With regard to the output signals from the video controller 200, the analog RGB signals processed in the video controller 200 and the audible signals passed through the video controller 200 are fed to the display device 300.

The video controller 200 comprises four types of electronic circuits. The fist circuits are intensity control circuits 201T, 201R, 201G and 201B for controlling the intensity of video images to be displayed on the display device 300 by varying control signals to be applied to each intensity control circuit.

The second circuits are filter circuits including a high pass filter 203, a band pass filter 204 and a low pass filter 205 for separating the audible signals into three frequency ranges, regulation circuits or rectifier circuits 206T, 206R, 206G and 206B for rectifying the filtered audible signals, which are used for the control signals of each channel of intensity control circuits 201T, 201R, 201G and 201B. The audible signals are fed to the high pass filter 203, the band pass filter 204, the low pass filter 205 and the rectifier circuit 206T through a demultiplexer 240, which is controlled by the video controller operation program 102 in the computer 101 (detail will be described later). The video controller operation program 102 is arranged to select an audible signal or a plurality of audible signals by using the demultiplexer 240 according to the instruction from the video controller operation program 102 or the instruction from the operator of the apparatus.

The third circuits are volume control circuits 210T, 210R, 210G, 210B, 211, 212A, 212B and 212C for adjusting the amplitudes of the rectified audible signals and a sound mixing and adjusting circuit 213 for mixing and adjusting each control signal to synthesize appropriate control signals of the intensity of the analog RGB signals. The volume control circuits 210T, 210R, 210G, 210B, 211, 212A, 212B, 212C and the sound mixing and adjusting circuit 213 are arranged to be manipulated by the video controller operation program 102 which runs on the computer 101 or by manually by using the volume control knobs provided on the front panel (not shown) of the video controller 200.

The fourth circuit is a data controller 250 for controlling respective functional sections such as, the demultiplexer 240 for separating the series of audible signals from the audiovisual computer system 100 into a plurality of audible signals in a parallel form and gating the audible signals, the volume control circuits 210T, 210R, 210G, 210B, 211, 212A, 212B, 212C or the sound mixing and adjusting circuit 213. The video controller operation program 102 and/or utility program 103 controls functional sections of the video controller 200 through the data controller 250. In FIG. 2, control lines from the data controller 250 for manipulating respective functional sections are omitted.

In addition to the circuitry described above, the video controller 200 is arranged to adjust, record and reproduce the control signals.

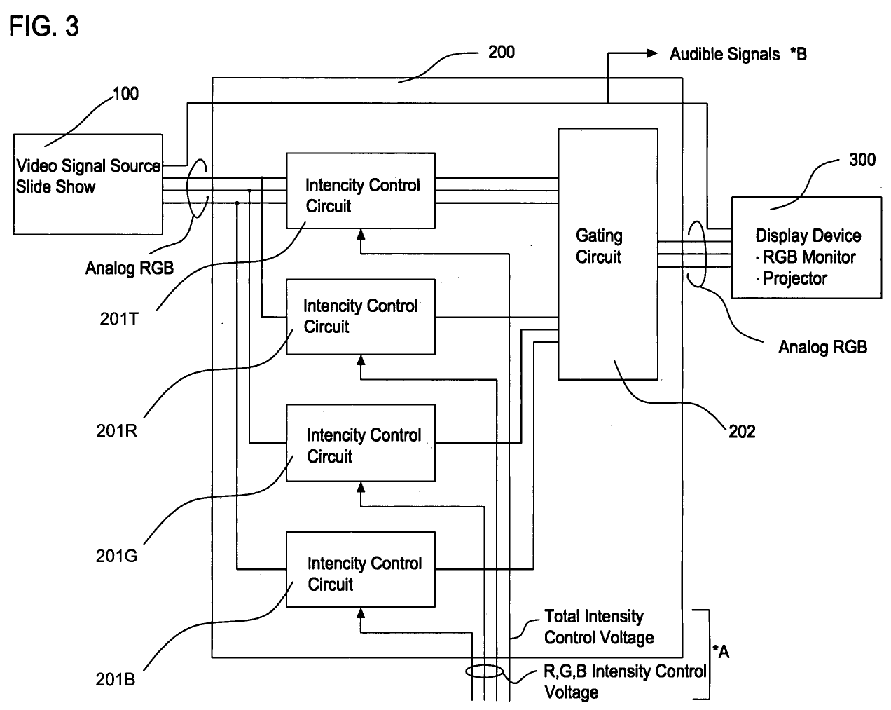

The operation of each circuit in the video controller 200 will be explained in detail by using FIGS. 3-7 below. FIG. 3 is a schematic block diagram of circuitry for varying the intensity of each component of analog R.G.B. signals. The circuitry here is formed in the video controller 200. A video signal source including video image signals including a still picture and audible signals and/or side show data in the audio visual computer system 100 is fed to the video controller 200. All of the video signals are fed to an intensity control circuit 201T while each video component signal of the analog R.G.B signals is separately inputted to the intensity control circuits 201R, 201G and 201B for varying the intensity of each video component signal.

The intensity control circuit 201T, 201R, 201G and 201B are arranged to vary the gain of each circuit of each video component signal by applying control signals each being a direct current (DC) voltage. Since various kinds of variable gain amplifier ICs (Integrated Circuits) controlled by DC voltage are available in the market place, for example, LMH 6502 of National Semiconductor, the detailed description of the circuit itself will be omitted here.

It is well know that intensity Y is defined by each of the component singles R, G and B of the analog R.G.B. as following formula (1).

Y=0.299*R+0.587*G and 0.114*B (1)

Accordingly, it is possible to vary the intensity Y by varying the signal level of each component signal of the analog R.G.B. signals. According to the formula (1), the intensity Y becomes high when the amplitude of one of the component signals R, G and B increases. However, since the coefficient of each term of the formula (1) is different, the contribution degree to the intensity of each color is different. Accordingly, this characteristic is effectively utilized for creation of effective presentation of the video signals.

In this embodiment, by independently applying the control signals (DC voltage waveform) to any one of intensity control circuits 201R, 201G and 201B of respective video component signals, it becomes possible to independently regulate the intensity of the analog RGB signals. It is also possible that, when varying the control signals of the intensity control circuit 201T, it becomes possible to regulate the intensity of the analog RGB signals at the same timing.

In this embodiment, the intensity control circuit 201T, which can control the analog R.G.B signals at same time, is provided in addition to the intensity control circuits 201R, 201G and 201B each being used for independently varying the amplitude of each video component of the analog R.G.B signals.

In FIG. 3, a gating circuit 202 for selecting necessary video signals according to an audiovisual application is provided. The output signals of the gating circuit 202 are fed to the display device 300 together with the audible signals. With regard to the gating circuit 202, analog switches and their switching signals establish the gating circuit 202. Since various types of analog switches are available in the marketplace for several semiconductor manufacturers, for example, NC7WB66 (Normally open analog switch or 2-bit bus switch) from Fairchild Semiconductor, the detailed circuit configuration will be omitted here.

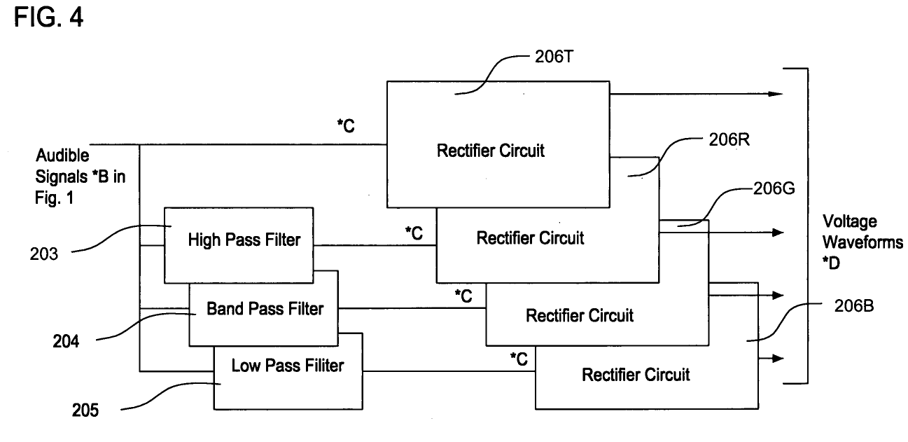

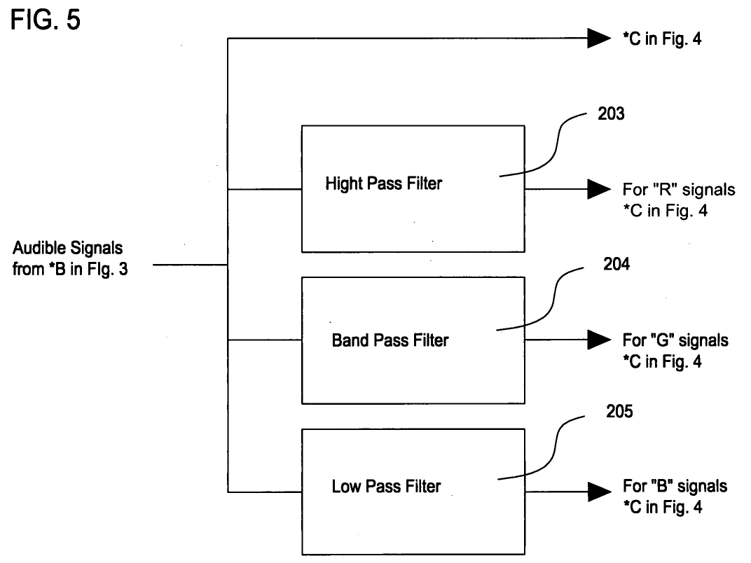

Next, the circuitry for synthesizing the control signals of the intensity for each video component signal of the analog R.G.B. signals will be described with reference to FIGS. 4 and 5. FIG. 4 is a schematic diagram of circuitry for filtering and regulating the audible signals into direct current (DC) voltage. The resultant DC voltage will be used as the control signals for varying the intensity of each component signal of the analog R.G.B signals, which are fed to the intensity control circuits 201T, 201R, 201G and 210B.

In this embodiment, the audible signals outputted from the audiovisual computer system 100 are divided into three frequency ranges by a high pass filter 203, a band pass filter 204 and a low pass filter 205. Each filter passes the audible signals in a specific frequency range, and three frequency ranges may be selected to be mutually exclusive, or to be overlapped. In this embodiment, the low pass filter 205 passes the audible signals having frequency not more than 60 HZ, the band pass filter 204 passes the audible signals having frequency range of from 100 Hz to 400 HZ, and the high passes filter 203 passes the audible signals having frequency not less than 1000 Hz.

In order to prevent the deterioration in the signal to noise ratio of the video signals from outside of the audible frequency range, the audible signals having frequency range of less than 15 Hz and more than 20,000 Hz are arranged to be cut off in an overall frequency range of the low pass filter 205 and the high pass filter 203. In this embodiment, the high pass filter 203, band pass filter 204 and low pass filter 205 are configured by linear operational amplifier ICs and CR (Capacities and Resisters) circuits. Since the filter configuration is a well known technology, the detailed description will be omitted here.

The audible signals fed to the high pass filer 203, the band pass filter 204 and the low pass filter 205 are also fed to the rectifier circuit 206T to form the control signals to be communicated to the intensity control circuit 201T. The output signals of the high pass filter 203, band pass filter 204 and the low pass filter 205 are separately fed to the rectifier circuits or regulation circuits 206R, 206G and 206B to form the control signals to be communicated to the intensity control circuits 201R, 201G and 201B. The rectifier circuits 206T, 206R, 206G and 206B separately seek the mean amplitudes of the audible signals themselves and respective output the signals of the high pass filter 203, the band pass filter 204 and the low pass filter 205.

The mean amplitudes of the audible signals will be fed to the mixing and adjusting circuit 213 through the volume control circuits 210T, 210R, 210G and 210B as illustrated in FIG. 2 to produce the control signals to control the intensity of each component signals of the analog R.G.B signals. The mean amplitudes of the audible signals passed through the high pass filter 203, the band pass filter 204 and the low pass filter 205 are respectively fed the intensity control circuit 201R, 201G and 201B through which the intensity of each R, G and B component signals of the analog R.G.B. signals are regulated in this embodiment. However, it should be noted that the present invention is not limited to this particular combination. The combination between the frequency ranges and the intensity control circuits may be changed according to each application.

The rectifier circuits 206T, 206R, 206G and 206G are provided so that the human eyes can recognize the intensity change of each component signals outputted from the intensity control circuits 201T, 201R, 201G, and 201B. The time constant of the CR (capacitor and resister) circuit associated with the rectifier circuits 206T, 206R, 206G and 206B are selected so that the intensity change of each channel can be recognized by the human eye.

FIG. 5 is one of examples illustrating the relationship between the three types of filters and corresponding signal components of RGB signals. As shown in FIGS. 2 and 4, in this embodiment, the audible signals passed through the high pass filter 203 are communicated to the intensity control circuit for “R” signals of the analog R.G.B. signals through the rectifier circuit 206R. The same as above, the audible signals passed through the band pass filter 204 communicated to the “G” signals of the analog R.G.B. signals and the audible signals passed through the low pass filter 205 communicated to the “B” signals of the analog R.G.B. signals. The combination between filters of the high pass filter 203, the band pass filter 204 and the low pass filter 205, and the component signals of the analog R.G.B. signals may be changed according to the object of the presentation. By changing the combination between the filters and the each component of the analog R.G.B signals, the expression can be changed even when the same video image is used.

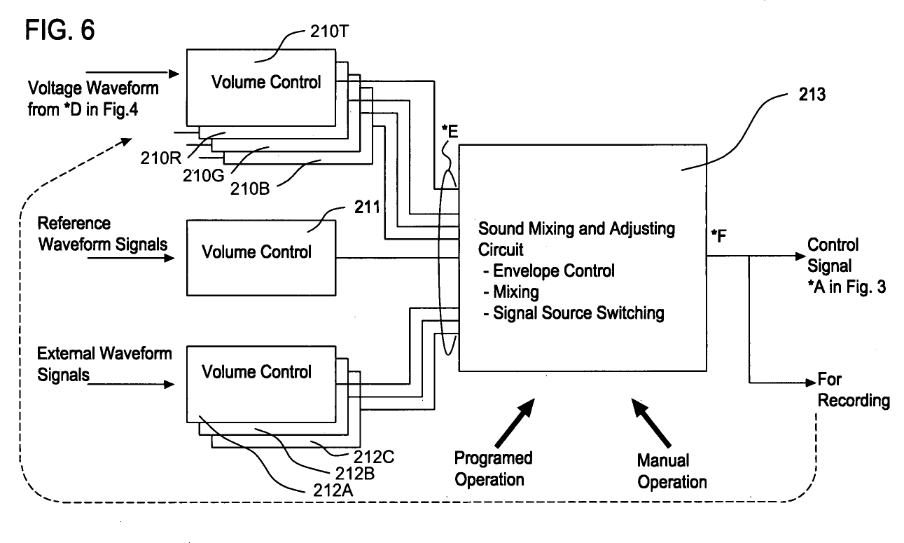

FIG. 6 is a schematic diagram of a part of functional block for producing control signals in the video controller 200. In this embodiment, three types of signal sources are provided as source signals of the control signals for controlling the intensity of the video signals.

The first signal source is audible signals separately passed through the filter circuits including the high pass filter 203, the band pass filter 204, the low pass filter 205 and the rectifier circuits 206T, 206R, 206G and 206B shown in FIG. 4. In this embodiment, the audible signal associated with the video image, for example, narration related to the video images or background music recorded with the video image is used as the first signal source.

The second source is a reference waveform signal, which is used as a reference signal level. This reference waveform signal is manually or automatically added to the control signals for varying the intensity of the analog R.G.B signals apart from the first signal source. In this embodiment, predetermined envelopes, which have been registered in advance to the computer 101 is fed as the second audible source (this will be described later in detail). By adding the reference waveform signal, the total intensity of the video images to be presented on the display 300 can be changed based the atmosphere of the surrounding where the video image is presented apart from the audible signals associated with the video images.

The third signal source is an external waveform signal for adding special effects in addition to the effects generated by the first and the second signal source. For example, sound of a metronome marking can be used, which can add rhythmic sense to the brightness or intensity of the video images to be presented on the display device. Even supra recitation may also be used as the external waveform signal, which gives special brightness effects on the video images to be presented on the display device.

The volume control circuits 210T, 210R, 210G, 210B, 211, 212A, 212B and 212C are connected to respective waveform signals as shown in FIG. 6, to independently adjust the amplitude of each control signal before summing the output signals from each volume control circuit. Respective voltage levels of control signals of the intensity control circuits 201T, 201R, 201G and 201B are designed to be independently adjusted. This makes it possible to provide wide range of the controls of the intensity of the video images. It is also possible to apply the output signal from the rectifier circuits 206R, 206G and 206B directly to the intensity control circuits 201R, 201G and 201B. However, in this case, the intensity of each R.G.B. signal channel cannot be independently adjusted.

All the output signals from the volume controls 210T, 210R, 210G, 210B, 211, 212A, 212B and 212C are fed to the sound mixing and adjusting circuit 213. The sound mixing and adjusting circuit 213 is designed so that the necessary signal sources are selected and mixed together to form the control signal to be fed to the intensity control circuits 201T, 201R, 201G and 201B. The sound mixing and adjusting circuit 213 is controlled by the video controller operation program 102 running on the computer 101 or by manually adjusting the control knobs and control switches provide on the console (not shown) of the video controller 200, which will be described in detail later.

The control signal or intensity control voltage outputted from the sound mixing and adjusting circuit 213 is arranged to be recorded so that the same control signal can be repeatedly used for future presentation of the video images.

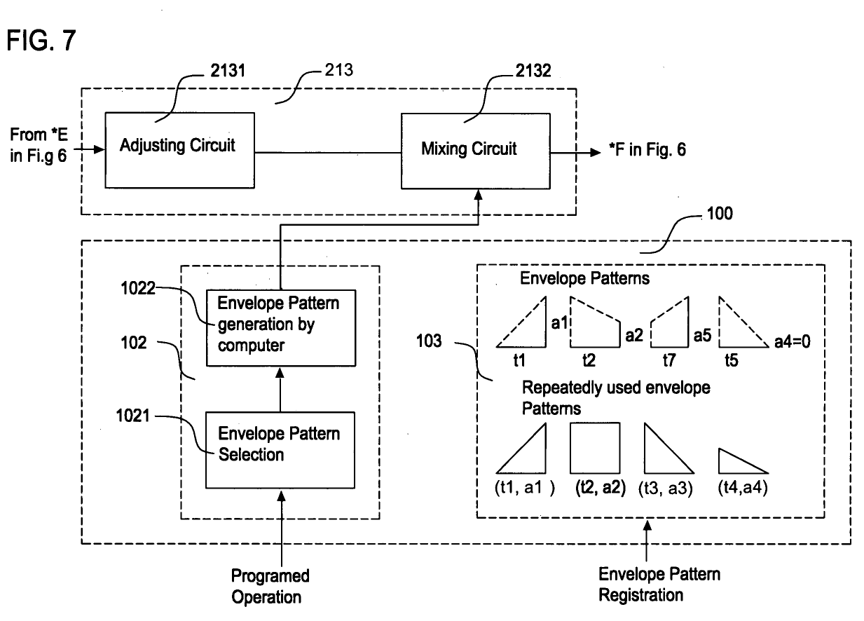

FIG. 7 illustrates the relationship between a functional block diagram of the sound mixing and adjusting circuit 213 and the utility program 103 in the audiovisual computer system 100 shown in FIGS. 1 and 6.

The sound mixing and adjusting circuit 213 includes adjusting circuit 2131 for independently adjusting the signals from the respective volume controls 210T, 210R, 210G, 210B, 211, 212A, 212B and 212C configured by analog electronic volumes and a mixing circuit 2132 for mixing the output signals from the volume controls 201T, 211, 212A, 212B and 212C (FIG. 3), which are controlled by the video controller operation program 102 running on the computer 101. By using the mixing circuit 2132, it becomes possible, for example, to mix the reference waveform signals passed through the volume control 211 with the voltage waveform passed through the volume control 210T to form the intensity control voltage to be applied to the intensity control circuit 201T. The same as above, it becomes possible to mix the external waveform signal passed through the volume controls 212A, 212B and/or 212C with the voltage waveform passed through the volume control 210T to form the intensity control voltage to be applied to the intensity control circuit 201T.

The adjusting circuit 2131 is also arranged to be manually controlled by the operator of the apparatus or by the video controller operation program 102.

In this embodiment, the mixing circuit 2132 mixes the output signals from the volume controls 211, 212A, 212B and 212C with the respective signals from the volume controls 210R, 210G and 210B. However, it is also possible to directly connect the output signals from the volume controls 210R, 210G and 210B to the intensity control circuits 201R, 201G and 201B without passing through the mixing circuit 2132. However, in such an arrangement, the reference waveform signal and the external waveform signal cannot be mixed with the output signals from the volume controls 210R, 210G and 210B.

The utility program 103 includes a function for registering various envelope patterns shown in FIG. 7. The envelope pattern to be resisted is characterized by a duration time, initial amplitude and ending amplitude when the envelope pattern is registered into the computer 101. As shown in FIG. 7, the first envelope patter has a duration time of t1 with zero initial amplitude and ending amplitude of a1. The following envelope pattern has the duration time of t2 with the initial amplitude of a1 and the ending envelope of a2. The same method can be applied when registering the envelope pattern in the memory (not shown) of the computer 101. It is recommended that the envelope patterns that will be repeatedly used as shown in FIG. 7 should be registered in advance so that reproduction can be effectively conducted.

Once the envelope pattern has been memorized in the memory (not shown) in the computer 101, the memorized envelope pattern can be repeatedly used. The video controller operation program 102 is arranged to automatically reproduce the video signals while varying the intensity of the video signals with the memorized envelope pattern appropriately selected by the video controller operation program 102. By using an envelope pattern selection function 1021 in the video controller operation program 102, one of the envelope patterns can be assigned. The selected envelope pattern data is sent to an envelope pattern generator 1022 in which the specified envelope pattern is called from the registered envelope patterns in the memory (not shown). Then the specified envelope pattern is transferred to the sound mixing and adjusting circuit 213 to form the intensity control voltage.

The sound mixing and adjusting circuit 213 is also arranged so that the external waveform singles modulate the audible signals passed through the volume control signal circuit 210T with the predetermined envelope pattern or the envelope pattern of the external waveform signals. In this embodiment, in addition to the volume control 212A, further volume controls 212B and 212C are incorporated for adding a total of three external waveform signals at the same time.

Followings are various effects of the embodiment of the present invention.

By registering the envelope patterns frequently used for special video image effects, for example, fade-in which gradually starts video images from low intensity levels toward higher intensity levels as the video images proceed, fluctuations of the intensity in the middle of the presentation of the video images and fade-out, which slowly ends video images from the high intensity level to lower intensity level can be added to the video images to be presented on the display device.

With regard to the registration of the envelope patterns, the program 103 includes a subprogram for registering an envelope, which is repeatedly used, characterized by a time duration and amplitude of the envelope in advance as illustrated in FIG. 7.

The video controller 200 is arranged to record the control signals, which is the output signals of the sound mixing and adjusting circuit 213 so that the same control signals, which previously played can be reused in the future play of the video images. This function is particularly useful when repeatedly presenting the same video images.

As described above, it becomes possible to enjoy, for example, the following four types of play of video images with varying intensity of the video images.

### [Live Play]

When video images to be displayed on a display device is provided independently from audible signals, for example, when displaying the photographs, it becomes possible to vary the intensity of the video images by appropriately selecting one of the frequency band from the three types of frequency ranges described above, and adjusting the intensity of the video images by manually or automatically controlling the level of the second audible signal, which enables to vary the intensity of the video image based on the contents or atmosphere where the video images are presented apart from the brightness which the video image itself posses.

It is further possible to vary the intensity of the video images by adjusting the intensity of the video images by applying specific envelope provided in advance onto the control signals of the intensity control circuits. It also becomes possible to vary the intensity of the video images by adding external sound source signals, such as metronome sound onto the control singles. Further, it becomes possible to adjust the amplitude of each audible signal source so that varieties of option for changing the intensity of the video images become available.

### [Direct Play]

Direct play means to play the movie while changing the intensity of the video images by inputting the associated sound tracks to the video controller 200. In this case, emotions associated with the scene in the movie can be presented on the intensity of the display onto which the movie film is displayed. Accordingly, voices recorded along with the video story can be reflected on the intensity of the video display.

### [Program Play]

Program play means to play the slide show, for which the slide show program and the audible signal-editing program have used to create. In this case the audible signals can be played back along with the video images wherein the audible signals have been used for modulating the control signals to vary the intensity of the video image when the video image is played back. It becomes possible to use different audible signals to be reproduced together with the reproduction of the video images.

### [Reproduction Play]

The video images played back based on the live play and program play described above can be recorded and played back in future. It is also possible to edit the video presentation by using an edit program.

Further, it is also possible to play the video images even when removing the computer from the audiovisual system 100 if sound and video image sources are provided and the video controller 200 is modified so that the sound and video image signal can be connected to the video controller 200. However, it is preferable that the computer is used to run the application programs for reproducing the audiovisual contents and recording the necessary data associated with the video images and audible signals.

Although the invention is described herein with reference to the preferred embodiment, one skilled in the art will readily appreciate that various modifications and variations may be made without departing from the spirit and scope of the present invention. Such modifications and variations are considered to be within the purview and scope of the appended claims and their equivalents.

What is claimed is:

1. An apparatus for controlling video signals to be presented on a display device associated with a first audible signal, the apparatus comprising:
an intensity controller for receiving the video signals having a plurality of video signal components, the intensity controller being arranged so that an intensity control voltage independently controls amplitude of at least one of the plurality of video component signals to vary intensity of the of the video singles;
a filter for receiving the first audible signal and separating the first audible signal into a plurality of filtered audible signals, respective filtered audible signals being characterized by different frequency ranges; and
a regulating circuit for regulating the filtered audible signal to form the intensity control voltage.

2. The apparatus for controlling video signals as defined in claim 1,
wherein the video signals are analog RGB signals and the plurality of video signal components correspond to R, G and B signals of the analog RGB signals.

3. The apparatus for controlling video signals as defined in claim 2,
wherein the filter includes a high pass filter, a band pass filter and a low pass filter.

4. The apparatus for controlling video signals as defined in claim 2, further comprising:
a first volume control device for varying level of the intensity control voltage.

5. The apparatus for controlling video signals as defined in claim 4, further comprising:
a second audible signal source; and
a second volume control device for varying amplitude of a second audible signal of the second signal source;
wherein the second audible signal are used for varying level of the intensity control voltage.

6. The apparatus for controlling video signals as defined in claim 5,
wherein the second audible signal can be manually adjusted.

7. The apparatus for controlling video signals as defined in claim 5,
wherein the second audible signal can be adjusted by a program running on a computer connected to the apparatus.

8. The apparatus for controlling video signals as defined in claim 7,
wherein the program includes a subprogram for registering envelope so that at least one of amplitude of one of R, G and B signals can be shaped according to the envelope.

9. The apparatus for controlling video signals as defined in claim 8,
wherein the envelope is characterized by a time duration and amplitude of the envelope when the envelope is registered.

10. The apparatus for controlling video signals as defined in claim 2,
wherein the intensity control voltage is fed to the intensity controller of each R, G and B signals at the same timing.

11. The apparatus for controlling video signals as defined in claim 2,
wherein the intensity control voltage is subsequently fed to the intensity controller of each R, G and B signals.

12. The apparatus for controlling video signals as defined in claim 5, further comprising:
a third volume control device for receiving a third audible signal to be mixed with the intensity control voltage.

13. The apparatus for controlling video signals as defined in claim 12,
wherein at lease one of the first volume control device, the second or the third volume control device is manually controlled.

14. The apparatus for controlling video signals as defined in claim 12,
wherein at lease one of the first volume control device, the second volume control device or the third volume control device is controlled by the program.

15. A method for controlling video signals to be presented on a screen associated with audible signals including a first audible signal in a control apparatus, the method comprising the steps of:
receiving the video signals having a plurality of video signal components;
controlling amplitude of at least one of the video signal components by using an intensity control voltage to control amplitude of at least one of the video signal components signals;
receiving the first audible signals;
separating the first audible signals into a plurality of filtered audible signals, respective filtered audible signals being characterized by different frequency ranges; and
regulating at least one of filtered audible signals to form the intensity control voltage.

16. The method for controlling video signals as defined in claim 15,
wherein the video signals are analog RGB signals and the plurality of video signal components correspond to R, G and B signals of the analog RGB signals.

17. The method for controlling video signals as defined in claim 16,
wherein the step of separating the first audible signals are performed by a high pass filter, a band pass filter and a low pass filter.

18. The method for controlling video signals as defined in claim 16, further comprising the steps of:
varying level of at least one of the intensity control voltage.

19. The method for controlling video signals as defined in claim 18,
wherein the audible signal further comprises a second audible signal source and the video controller further comprises a second volume control device for varying amplitude of second signals of the second signal source;
wherein the second signals are used for varying the level of the control signals.

20. The method for controlling video signals as defined in claim 19,
wherein the second audible signals can be manually adjusted.
